(19) United States
(12) Patent Application Publication
(10) Pub. No.: US 2015/0102754 A1
(43) Pub. Date: Apr. 16, 2015

(54) APPARATUS FOR DRIVING MOTOR AND CONTROLLING METHOD THEREOF

(71) Applicant: SAMSUNG ELECTRO-MECHANICS CO., LTD., Suwon-si (KR)

(72) Inventor: Bon Young Gu, Suwon-si (KR)

(73) Assignee: SAMSUNG ELECTRO-MECHANICS CO., LTD., Suwon-si (KR)

(21) Appl. No.: 14/170,422

(22) Filed: Jan. 31, 2014

(30) Foreign Application Priority Data
Oct. 16, 2013 (KR) 10-2013-0123540

(51) Int. Cl. H02P 6/08

(52) U.S. Cl. CPC H02P 6/08
USPC 318/400.17

(57) ABSTRACT

Disclosed herein is an apparatus for driving a motor, the apparatus including: an inverter applying a direct current voltage to each phase of a brushless direct current (BLDC) motor by a switching operation; a reference voltage generating unit generating at least one reference voltage using a voltage of a neutral point of the BLDC motor; and a motor driver detecting a zero cross point (ZCP) of back electromotive force of each phase by comparing a phase voltage of each phase of the BLDC motor with the reference voltage and generating a PWM signal for controlling the switching operation of the inverter and a phase switching of each phase using information of a position of the zero cross point (ZCP).

### CROSS REFERENCE TO RELATED APPLICATION

This application claims the benefit of Korean Patent Application No. 10-2013-0123540, filed on Oct. 16, 2013, entitled “Apparatus for Driving Motor and Controlling Method thereof”, which is hereby incorporated by reference in its entirety into this application.

### BACKGROUND OF THE INVENTION

1. Technical Field

The present invention relates to an apparatus for driving a motor and a controlling method thereof.

2. Description of the Related Art

In general, since a direct current motor (DC motor) has a linear relationship between an applied voltage and a speed, it has a simple speed control and a wide speed control range. However, the DC motor has a brush as an essential component to maintain torque in one direction. Therefore, it was difficult to drive at a high speed due to the brush, maintenance was frequent due to abrasion of the brush, and a noise, or the like was serious.

In order to solve the above-mentioned problems, a brushless DC motor (called a BLDC motor) was suggested, wherein the brushless DC motor is configured by a stator having a coil wound in a direction opposite to a typical DC motor and a rotor having a permanent magnet and obtains rotation force by controlling a current flowing in the coil of the stator to thereby control magnetic flux of the stator and magnetic flux of the permanent magnet of the rotor so as to have a right angle or any angle.

Since the BLDC motor does not include the brush, it solves disadvantages of the DC motor according to the prior art, and since it has advantages of the DC motor as it is, it has been recently and widely used. In order to appropriately control magnetic flux, a switching state of an inverter switching devices need to be determined so that a magnetic generation position of the stator is determined depending on a position of the rotor. In order to detect the position of the rotor, even though a sensor such as a hall sensor, or the like may be used, a sensor-less scheme detecting position information of the rotor by detecting a zero cross point (ZCP) by back electromotive force without using the sensor is mainly used due to environmental factors such as a temperature, a pressure, and the like.

Therefore, in the above-mentioned sensor-less scheme, according to the prior art, as described in the following prior art document, the zero cross point (ZCP) is detected by comparing the back electromotive force of each phase induced from the stator with a reference voltage. In the BLDC motor, in the case in which an error is generated in the phase voltage and the reference voltage due to mismatch of an inductor, and the like, an accuracy of the detection of the zero cross point (ZCP) is decreased, such that a position detection of the rotor may become uneven and a timing of switching a phase of the motor may become irregular.

### PRIOR ART DOCUMENT

### Patent Document

(Patent Document 1) 2006-0068844KR

### SUMMARY OF THE INVENTION

The present invention has been made in an effort to provide an apparatus for driving a motor capable of more accurately detecting a zero cross point (ZCP) by comparing back electromotive force of each phase with at least one reference voltage in order to secure reliability in driving a BLDC motor, and a controlling method thereof.

According to a preferred embodiment of the present invention, there is provided an apparatus for driving a motor, the apparatus including: an inverter applying a direct current voltage to each phase of a brushless direct current (BLDC) motor by a switching operation; a reference voltage generating unit generating at least one reference voltage using a voltage of a neutral point of the BLDC motor; and a motor driver detecting a zero cross point (ZCP) of back electromotive force of each phase by comparing a phase voltage of each phase of the BLDC motor with the reference voltage and generating a PWM signal for controlling the switching operation of the inverter and a phase switching of each phase using information of a position of the zero cross point (ZCP).

The inverter may include transistors controlled by the PWM signal of the motor driver and diodes each connected to the transistors in anti-parallel.

The reference voltage generating unit may generate first and third reference voltage having a predetermined voltage difference with a second reference voltage based on a voltage of a neutral point as the second reference voltage.

The motor driver may include a plurality of comparators for each phase and a plurality of registers connected to the comparators in series, the back electromotive force may be input to each of the non-inverting terminals of the comparators, the plurality of reference voltage may be input to each of the inverting terminals, and outputs of the comparators may be stored in the registers.

The motor driver may include: a ZCP detecting module detecting the zero cross point (ZCP) of each phase by each comparing the back electromotive force of each phase with at least one reference voltage; a controlling module measuring a position and a rotation speed of a rotor using information of the detected zero cross position; and a PWM signal generating module generating a PWM signal for controlling a phase switching timing of each phase based on the position of the rotor and speed information of the motor.

The motor driver may include an initial driving circuit providing information for the zero cross point (ZCP) for the phase switching of each phase to the PWM signal generating module at the time of an initial drive.

The ZCP detecting module may include a U phase detecting circuit, a V phase detecting circuit, and a W phase detecting circuit each including a plurality of comparators and a plurality of registers connected to the comparators in series, the back electromotive force of each phase may be input to non-inverting terminals of the comparators of the detecting circuit of each phase, the plurality of reference voltage may be input to each of the inverting terminals, and outputs of the comparators may be sequentially stored in the registers.

The register may be a flip-flop.

The controlling module may include: a position measuring circuit measuring the position of the rotor using information of a position at which the zero cross point is generated; a speed measuring circuit measuring the speed of the rotor using information of a time interval at which the zero cross point is generated; and a controller controlling a phase switching of each phase by the PWM signal generating module based on the position of the rotor and speed information of the motor.

The PWM signal generating module may include: a PWM generating circuit generating a PWM signal applied with a duty ratio determined by the controller in order to control the rotation speed of the rotor; a driving signal generating circuit generating a driving voltage for deriving the phase switching of each phase using the PWM signal; and a gate driver operating transistors of the inverter using the driving signal based on phase switching information of each phase applied from the controller.

According to another preferred embodiment of the present invention, there is provided a controlling method of an apparatus for driving a motor, the controlling method including: generating at least one reference voltage; detecting a zero cross point (ZCP) determining whether or not the zero cross point (ZCP) is detected by comparing a phase voltage of each phase of a BLDC motor with the reference voltage; and determining a phase switching determining whether or not the phase switching of each phase is performed depending on whether or not the zero cross point (ZCP) is detected.

In the generating of the reference voltage, first and third reference voltage having a predetermined voltage difference with a second reference voltage may be generated based on a voltage of a neutral point as the second reference voltage.

The detecting of the zero cross point may include: comparing back electromotive force of each phase input to each of the non-inverting terminals of a plurality of comparators provided for each phase with at least one reference voltage; storing each of the outputs of the plurality of comparators of each phase by a plurality of registers; and determining whether or not the zero cross point is detected based on data stored in the register.

In the case in which the zero cross point (ZCP) is detected, the determining of the phase switching may include: measuring a position and a rotation speed of a rotor using information of the detected zero cross point (ZCP); generating a PWM signal based on the position and the rotation speed of the rotor; and controlling the performing of the phase switching of each phase by a switching operation of an inverter using the PWM signal.

In the case in which the zero cross point (ZCP) is not detected, in the determining of the phase switching, the comparing of the phase voltage of each phase of the BLDC motor with the reference voltage may be re-performed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing an apparatus for driving a motor according to a preferred embodiment of the present invention;

FIG. 2 is an entire circuit diagram showing the apparatus for driving the motor according to the preferred embodiment of the present invention;

FIG. 3A is a circuit diagram showing a ZCP detecting module according to the preferred embodiment of the present invention and FIG. 3B is a circuit showing a U phase detecting circuit included in the ZCP detecting module;

FIGS. 3C and 3D are views showing output patterns of first to third comparators included in the U phase detecting circuit;

FIGS. 4A and 4B are views showing phase voltage of a BLDC motor and a timing of performing the phase voltage of each phase according to a preferred embodiment of the present invention; and

FIG. 5 is a view showing a controlling method of the apparatus for driving the motor according to a preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

Hereinafter, an apparatus for driving a motor and a controlling method thereof according to a preferred embodiment of the present invention will be described in detail with reference to the accompanying drawings. A zero cross point (ZCP) refers to a point at which back electromotive force (phase voltage) of each phase crosses a reference voltage.

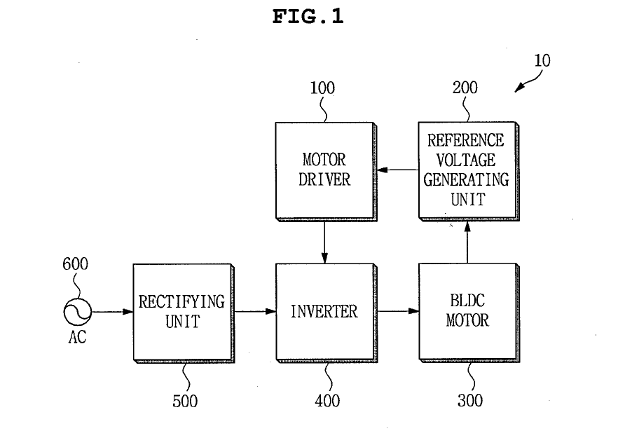

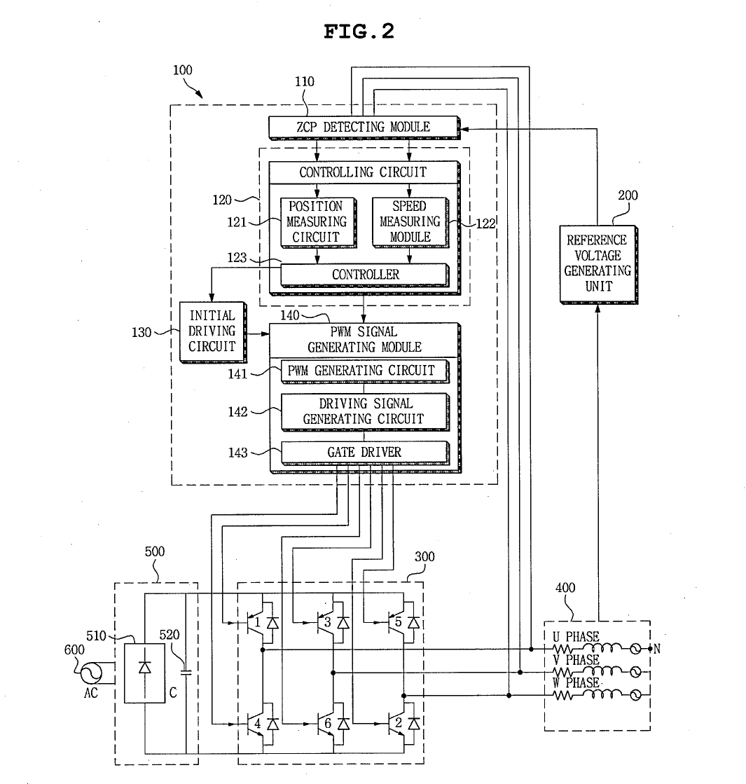

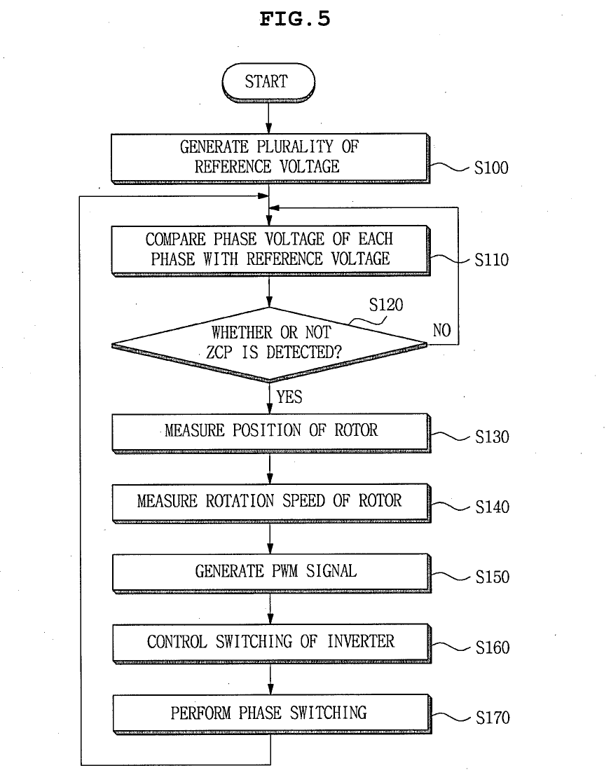

FIG. 1 is a block diagram showing an apparatus for driving a motor according to a preferred embodiment of the present invention, FIG. 2 is an entire circuit diagram showing the apparatus for driving the motor according to the preferred embodiment of the present invention, and FIG. 5 is a flowchart showing a controlling method of the apparatus for driving the motor according to a preferred embodiment of the present invention.

As shown in FIG. 1, an apparatus 10 for driving a motor according to a preferred embodiment of the present invention is configured to include input power 600, a rectifying unit 500, a motor driver 100, an inverter 300, a reference voltage generating unit 200, and a BLDC motor 400.

The rectifying unit 500 includes a rectifier 510 receiving and rectifying the input power (alternating current) 600 and a smoothing capacitor 520 smoothing the rectified input power 600, and applies the rectified and smoothed direct current (DC) voltage to the inverter 300.

The inverter 300 may be applied with the rectified and smoothed direct current voltage by the rectifying unit 500, may apply the direct current voltage to each phase of the BLDC motor through a switching operation, may include transistors controlled by a PWM signal of the motor driver 100 and diodes each connected to the transistors in anti-parallel, and may be applied with the direct current voltage by a direct current (DC) instead of the rectifying unit 500.

The reference voltage generating unit 200 generates at least one reference voltage using a voltage of a neutral point N of the BLDC motor (S100). That is, the reference voltage generating unit 200 generates first and third reference voltage having a predetermined voltage difference with a second reference voltage based on the voltage of the neutral point N as the second reference voltage to thereby apply the first and third reference voltage to the motor driver 100.

The motor driver 100 compares a phase voltage of each phase (U phase, V phase, or W phase) of the BLDC motor and the reference voltage (the first to third reference voltage) to thereby detect a zero cross point (ZCP) of back electromotive force (phase voltage) of each phase, and generates the PWM signal for controlling the switching operation of the inverter 300 and a phase switching of each phase using position information of the zero cross point (ZCP) in the case in which the zero cross point (ZCP) is detected.

In addition, the motor driver 100 includes a plurality of comparators (first to third comparators) for each phase (U phase, V phase, or W phase) and a plurality of registers connected to the comparators in series, in a floating section, the back electromotive force (phase voltage) of each phase (U phase, V phase, or W phase) is input to each of the non-inverting terminals (+) of the comparators, the plurality of reference voltage are input to each of the inverting terminals (−), and outputs of the comparators are sequentially stored in the registers.

In addition, the motor driver 100 may include an initial driving circuit 130 providing information for the zero cross point (ZCP) for the phase switching of each phase to the PWM signal generating circuit 140 at the time of an initial drive, and may include a ZCP detecting module 110, a controlling module 120, and the PWM signal generating module 140.

Here, the ZCP detecting module 110 each compares the back electromotive force (phase voltage) of each phase and at least one reference voltage by the plurality of comparators and registers for each phase (S110) to thereby detect the zero cross point (ZCP) of each phase (S120). A description thereof will be made below.

The controlling module 120 may measure a position and a rotation speed of a rotor using information of the detected zero cross point (ZCP), and the like, and may include a position measuring circuit 121, a speed measuring circuit 122, and a controller 123.

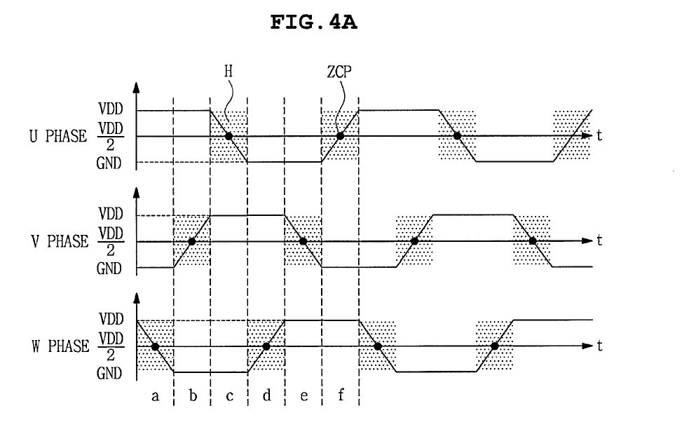

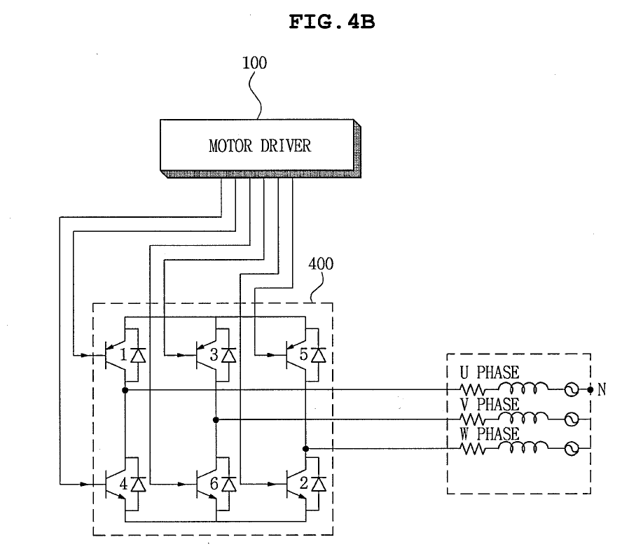

Here, the position measuring circuit 121 measures the position of the rotor using information of the position (see FIG. 4) at which the zero cross point (ZCP) is generated during a driving process of the BLDC motor (S130), the speed measuring circuit 122 measures the speed of the rotor using information of a time interval at which the zero cross point (ZCP) is generated (S140), and the controller 123 generates the PWM signal by the PWM signal generating module based on the position of the rotor and speed information of the motor to thereby control the phase switching of each phase (U phase, V phase, or W phase).

The PWM signal generating module 140 generates the PWM signal for controlling a phase switching timing of each phase based on the position of the rotor and speed information of the motor, and may include a PWM generating circuit 141, a driving signal generating circuit 142, and a gate driver 143.

Here, i) the PWM generating circuit 141 generates the PWM signal applied with a duty ratio determined by the controller in order to control the rotation speed of the rotor (S150), ii) the driving signal generating circuit 142 generates a driving voltage for deriving the phase switching of each phase using the PWM signal, iii) the gate driver 143 controls a switching operation (switch on/off) of the transistor of the inverter 300 by amplifying the driving signal based on phase switching information (the zero cross point, the detection position, and the like) of each phase applied from the controller 123 (S160), and the phase switching of each phase is performed by the switching operation of the inverter 300 (S170).

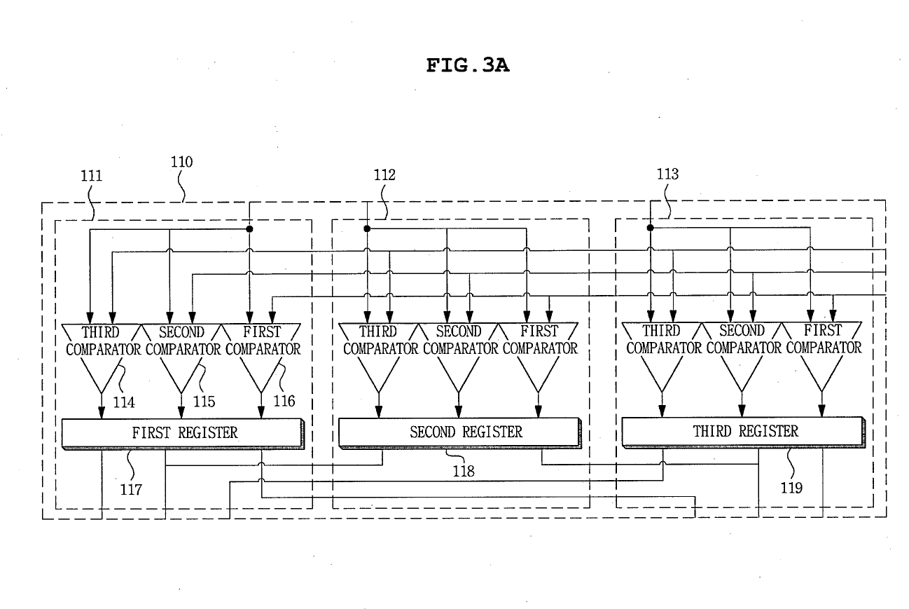

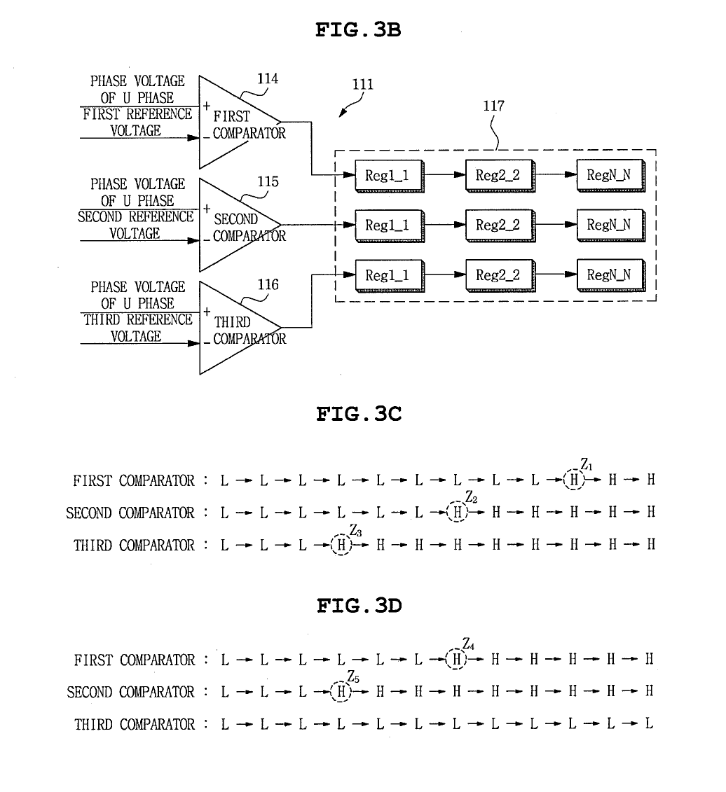

Hereinafter, a process of detecting the zero cross point (ZCP) in each phase in the ZCP detecting module will be described in detail with reference to FIGS. 3A to 3D.

FIG. 3A is a circuit diagram showing a ZCP detecting module according to the preferred embodiment of the present invention, FIG. 3B is a circuit diagram showing a U phase detecting circuit included in the ZCP detecting module, and FIGS. 3C and 3D are views showing output patterns of first to third comparators included in the U phase detecting circuit.

As shown in FIG. 3A, the ZCP detecting module 110 includes a U phase detecting circuit 111, a V phase detecting circuit 112, and a W phase detecting circuit 113 detecting the zero cross point (ZCP) of each phase by comparing the back electromotive force of each phase with a plurality of reference voltage, where the detecting circuits 111, 112, and 113 of each phase includes a plurality of comparators 114, 115, and 116 and a plurality of registers 117, 118, and 119 each connected to the respective comparators in series. Here, the registers 117, 118, and 119 may be a flip-flop.

That is, as shown in FIG. 3B, the U phase detecting circuit 111 may include three comparators 114, 115, and 116, where non-inverting terminals (+) of the respective comparators are commonly input with the back electromotive force (phase voltage) of the U phase, and inverting terminals (−) thereof are input with first to third reference voltage, respectively.

In addition, the first register 117 includes a plurality of registers (Reg_{—}1 to Reg_N) connected to the first to third comparators 114, 115, and 116, respectively, and outputs of the first to third comparators 114, 115, and 116 are sequentially stored in the plurality of registers (Reg_{—}1 to Reg_N), respectively.

For example, as shown in FIG. 3C, the non-inverting terminals (+) of the respective comparators included in the U phase detecting circuit 111 are commonly input with the back electromotive force (phase voltage) of the U phase, and the inverting terminals (−) thereof are input with the first to third reference voltage, respectively. In addition, the comparators 114, 115, and 116 output a high (H) or low (L) signal by a comparison between the back electromotive force (phase voltage) of the U phase and the first to third reference voltage, the plurality of registers (Reg_{—}1˜Reg_N) included in the first register 117 store an output data pattern (FIG. 3C) in which the high (H) or low (L) signal is sequentially stored, and the plurality of registers (Reg_{—}1˜Reg_N) connected to the respective comparators 114, 115, and 116 store the output data pattern as mentioned above.

That is, as shown in FIG. 3C, in the case in which an error (due to a mismatch of an inductor, or the like) is not generated between the back electromotive force (phase voltage) of the U phase and the second reference voltage (a voltage of the neutral point N=V_{DD}/2), the zero cross point (ZCP) of the U phase is detected at three points Z₁, Z₂, and Z₃ by the first to third comparators, and a real zero cross point may be a cross point Z₂ of the second reference voltage (a voltage of the neutral point N=V_{DD}/2) and the back electromotive force (phase voltage) of the U phase.

However, as shown in FIG. 3D, in the case in which the error (due to a mismatch of an inductor of the motor, or the like) is generated between the back electromotive force (phase voltage) of the U phase and the second reference voltage (a voltage of the neutral point N=V_{DD}/2), even though the zero cross point (ZCP) between the back electromotive force (phase voltage) of the U phase and the second reference voltage (a voltage of the neutral point N=V_{DD}/2) may not be generated, the zero cross point (ZCP) may be detected by comparing the first to third reference voltage with the back electromotive force (phase voltage) of the U phase by the plurality of comparators 114, 115, and 116.

That is, due to the error generated between the back electromotive force (phase voltage) of the U phase and the first to third reference voltage, the third reference voltage becomes lower than the back electromotive force (phase voltage) of the U phase, such that the zero cross point (ZCP) of the U phase may be detected at two points Z₄ and Z₅ by the first and second comparators 114 and 115, but the zero cross point (ZCP) between the back electromotive force (phase voltage) of the U phase and the third reference voltage in the third compartor 116 may not be generated.

Therefore, the real zero cross point of the U phase is a cross point of the second reference voltage (a voltage of the neutral point N=V_{DD}/2) and the back electromotive force (phase voltage) of the U phase. However, considering that magnitude of the first to third reference voltage becomes low by a predetermined portion due to the error generated between the back electromotive force (phase voltage) and the first to third reference voltage, the real zero cross point of the U phase may be a cross point Z₄ of the first reference voltage higher than the second reference voltage (a voltage of the neutral point N=V_{DD}/2) by a predetermined voltage and the back electromotive force (phase voltage) of the U phase.

As described above, in the sensor-less scheme detecting position information of the rotor by detecting the zero cross point by the back electromotive force of each phase, the apparatus for driving the motor according to the preferred embodiment of the present invention may secure accuracy of the detection of the zero cross point (ZCP) and the phase switching timing of each phase and may implement an optimal BLDC motor control by analyzing the pattern of output data stored in the plurality of register to thereby detect the zero cross point (ZCP) of each phase, even in the case in which the error is generated between the back electromotive force and the reference voltage due to the mismatch of the inductor of the motor, or the like.

Hereinafter, a process of performing the phase switching of each phase according to the back electromotive force (phase voltage) of each phase and the position of the zero cross point (ZCP) in the apparatus for driving the motor according to the preferred embodiment of the present invention will be described in detail with reference to FIGS. 4A and 4B.

FIG. 4A is a view showing a phase voltage form of each phase of the BLDC motor and FIG. 4B is a view showing a circuit diagram for performing the phase switching of each phase according to the detection position of the zero cross point (ZCP) of each phase.

As shown in FIG. 4A, the phase voltage of each phase of the BLDC motor is changed in a trapezoidal shape, and each phase (U phase, V phase, or W phase) includes a section to which power (V_{dd}) is applied, a ground section (GND), and a floating section (a section to which power is not applied) H (a dotted line region). In addition, through a to f steps, the rotor (not shown) of the motor is rotated 360°, and in general, when the zero cross point (ZCP) is detected, the phase switching is performed after an electrical angle of 30° therefrom.

That is, referring to FIGS. 4A and 4B, i) in a section a, first and sixth transistors (hereinafter, referred to as TR) are switched on by the motor driver, such that the U phase may become a power V_{dd} state, the V phase may become a GND state, and the W phase may become a floating state, and the zero cross point (ZCP) may be detected at the W phase, ii) in a section b, the first and second TRs are switched on by the motor driver, such that the U phase may become the power V_{dd} state, the V phase may become the floating state, and the W phase may become the GND state, and the zero cross point (ZCP) may be detected at the V phase, and iii) in a section c, the third and second TRs are switched on by the motor driver, such that the U phase may become the floating state, the V phase may become the power V_{dd} state, and the W phase may become the GND state, and the zero cross point (ZCP) may be detected at the U phase.

In addition, iv) in a section d, the fourth and third TRs are switched on by the motor driver, such that the U phase may become the GND state, the V phase may become the power V_{dd} state, and the W phase may become the floating state, and the zero cross point (ZCP) may be detected at the W phase, v) in a section e, the fourth and fifth TRs are switched on by the motor driver, such that the U phase may become the GND state, the V phase may become the floating state, and the W phase may to become the power V_{dd} state, and the zero cross point (ZCP) may be detected at the V phase, and vi) in a section f, the sixth and fifth TRs are switched on by the motor driver, such that the U phase may become the floating state, the V phase may become the GND state, and the W phase may become the power V_{dd} state, and the zero cross point (ZCP) may be detected at the U phase.

As described above, the apparatus for driving the motor according to the preferred embodiment of the present invention may more accurately detect the zero cross point (ZCP) of each phase and secure reliability for the timing of performing the phase switching of each phase by generating the plurality of reference voltage having a predetermined voltage difference based on the neutral point N by the ZCP detecting module and the reference voltage generating unit and comparing the reference voltage with the back electromotive force of each phase by the plurality of comparators.

According to the preferred embodiment of the present invention, the zero cross point (ZCP) of each phase may be more accurately detected by generating the plurality of reference voltage having a predetermined voltage difference based on the neutral point N by the ZCP detecting module and the reference voltage generating unit of the apparatus for driving the BLDC motor and comparing the reference voltage with the back electromotive force of each phase by the plurality of comparators.

In addition, in the sensor-less scheme detecting position information of the rotor by detecting the zero cross point by the back electromotive force of each phase, even in the case in which the error is generated between the back electromotive force and the reference voltage due to the mismatch of the inductor of the motor, or the like, the accuracy of the detection of the zero cross point (ZCP) and the phase switching timing of each phase may be secured and the optimal BLDC motor control may be implemented by analyzing the pattern of output data stored in the plurality of register included the ZCP detecting circuit of each phase to thereby detect the zero cross point (ZCP) of each phase.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An apparatus for driving a motor, the apparatus comprising:
an inverter applying a direct current voltage to each phase of a brushless direct current (BLDC) motor by a switching operation;
a reference voltage generating unit generating at least one reference voltage using a voltage of a neutral point of the BLDC motor; and
a motor driver detecting a zero cross point (ZCP) of back electromotive force of each phase by comparing a phase voltage of each phase of the BLDC motor with the reference voltage and generating a PWM signal for controlling the switching operation of the inverter and a phase switching of each phase using information of a position of the zero cross point (ZCP).

2. The apparatus as set forth in claim 1, wherein the inverter includes transistors controlled by the PWM signal of the motor driver and diodes each connected to the transistors in anti-parallel.

3. The apparatus as set forth in claim 1, wherein the reference voltage generating unit generates first and third reference voltage having a predetermined voltage difference with a second reference voltage based on a voltage of a neutral point as the second reference voltage.

4. The apparatus as set forth in claim 1, wherein the motor driver includes a plurality of comparators for each phase and a plurality of registers connected to the comparators in series,
the back electromotive force of each phase is input to each of the non-inverting terminals of the comparators, the plurality of reference voltage are input to each of the inverting terminals, and outputs of the comparators are sequentially stored in the registers.

5. The apparatus as set forth in claim 1, wherein the motor driver includes:
a ZCP detecting module detecting the zero cross point (ZCP) of each phase by each comparing the back electromotive force of each phase with at least one reference voltage;
a controlling module measuring a position and a rotation speed of a rotor using information of the detected zero cross position; and
a PWM signal generating module generating a PWM signal for controlling a phase switching timing of each phase based on the position of the rotor and speed information of the motor.

6. The apparatus as set forth in claim 5, wherein the motor driver includes an initial driving circuit providing information for the zero cross point (ZCP) for the phase switching of each phase to the PWM signal generating module at the time of an initial drive.

7. The apparatus as set forth in claim 5, wherein the ZCP detecting module includes a U phase detecting circuit, a V phase detecting circuit, and a W phase detecting circuit each including a plurality of comparators and a plurality of registers connected to the comparators in series,
the back electromotive force of each phase is input to non-inverting terminals of the comparators of the detecting circuit of each phase, the plurality of reference voltage are input to each of the inverting terminals, and outputs of the comparators are sequentially stored in the registers.

8. The apparatus as set forth in claim 7, wherein the register is a flip-flop.

9. The apparatus as set forth in claim 5, wherein the controlling module includes:
a position measuring circuit measuring the position of the rotor using information of a position at which the zero cross point is generated;
a speed measuring circuit measuring the speed of the rotor using information of a time interval at which the zero cross point is generated; and
a controller controlling a phase switching of each phase by the PWM signal generating module based on the position of the rotor and speed information of the motor.

10. The apparatus as set forth in claim 9, wherein the PWM signal generating module includes:
a PWM generating circuit generating a PWM signal applied with a duty ratio determined by the controller in order to control the rotation speed of the rotor;
a driving signal generating circuit generating a driving voltage for deriving the phase switching of each phase using the PWM signal; and
a gate driver operating transistors of the inverter using the driving signal based on phase switching information of each phase applied from the controller.

11. A controlling method of an apparatus for driving a motor, the controlling method comprising:
generating at least one reference voltage;
detecting a zero cross point (ZCP) determining whether or not the zero cross point (ZCP) is detected by comparing a phase voltage of each phase of a BLDC motor with the reference voltage; and
determining a phase switching determining whether or not the phase switching of each phase is performed depending on whether or not the zero cross point (ZCP) is detected.

12. The controlling method as set forth in claim 11, wherein in the generating of the reference voltage, first and third reference voltage having a predetermined voltage difference with a second reference voltage are generated based on a voltage of a neutral point as the second reference voltage.

13. The controlling method as set forth in claim 11, wherein the detecting of the zero cross point includes:
comparing back electromotive force of each phase input to each of the non-inverting terminals of a plurality of comparators provided for each phase with at least one reference voltage;
storing each of the outputs of the plurality of comparators of each phase by a plurality of registers; and
determining whether or not the zero cross point is detected based on an output data pattern stored in the register.

14. The controlling method as set forth in claim 11, wherein in the case in which the zero cross point (ZCP) is detected, the determining of the phase switching includes:
measuring a position and a rotation speed of a rotor using information of the detected zero cross point (ZCP);
generating a PWM signal based on the position and the rotation speed of the rotor; and
controlling the performing of the phase switching of each phase by a switching operation of an inverter using the PWM signal.

15. The controlling method as set forth in claim 11, wherein in the case in which the zero cross point (ZCP) is not detected, in the determining of the phase switching, the comparing of the phase voltage of each phase of the BLDC motor with the reference voltage is re-performed.
